(19) United States
(12) Patent Application Publication
(10) Pub. No.: US 2009/0096792 A1
(43) Pub. Date: Apr. 16, 2009

(54) FILL MODE DETERMINATION IN VECTOR GRAPHICS

(75) Inventor: Mika Henrik Tuomi, Noormarkku (FI)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 11/872,248

(22) Filed: Oct. 15, 2007

(51) Int. Cl. G06T 11/20

(52) U.S. Cl. 345/441

(57) ABSTRACT

An efficient method for improving use of different fill modes in vector graphics and a system using the method. The filling method uses a graphics hardware that is capable of producing objects to be filled. Before the actual filling the edges of the objects must be computed. Edges are then stored into an edge buffer. The buffer may be a separate buffer block or a pointer to a memory. The edge buffer comprises only the edges of the object to be rendered. When the object is actually is rendered, rendering function is called with at least one parameter. The parameters include the fill mode with which the object is rendered to the screen.

### FIELD OF THE INVENTION

The present invention relates to vector graphics rendering and particularly to a procedure for choosing the fill mode for the vector graphics object to be rendered.

### BACKGROUND OF THE INVENTION

In recent years, vector graphics systems and algorithms have been developed for achieving robust and exact visualization, and have been employed in demanding software applications, such as in computer aided design, graphics applications, and the like. The benefit of the employing vector graphics, include scalability without the loss of graphics quality. The vector in a drawing typically includes a starting point, a direction, and a length or an ending point. Thus, a line can be represented using vector graphics with reduced information, as compared to having to indicate each pixel of the line, as with other methods. Furthermore, the vector need not be a direct line, as curves, and the like, also can be employed which may require including additional information such as, for example, for defining a curve. The corresponding format employed during the execution of a corresponding graphical application, the file format for storing the corresponding graphical information, the fundamentals of vector graphics and the corresponding software applications employed, and the like, are well known to a person of ordinary skill in the art and will not be described in detail herein.

In addition, certain graphics standards have been developed, such as the OpenVG 1.0 standard by Khronos group of Jul. 28, 2005, incorporated by reference herein, and which includes an application programming interface (API) for hardware accelerated two-dimensional vector and raster graphics applications. The standard provides a device independent and vendorneutral interface for sophisticated two-dimensional graphical applications, while allowing device manufacturers to provide hardware acceleration on devices ranging from wrist watches, to full microprocessor-based desktop systems, to server machines, and the like.

The standard provides an interface for a set of functions that can be implemented by hardware and/or software drivers for rasterization, filling of polygons, and the like. In the standard, two different fill rules, a non-zero and an odd/even rule, are implemented, and are described at page 72 of the standard. It is obvious to a person of ordinary skill in the art that other standards may have further fill rules, such as negative or positive filling.

The basic principle of such filling technique employs the fact that each edge vector of a polygon has a direction, such that when the filling procedure arrives at the edge vector from the left, the filling procedure detects if the edge vector is going up or down. For example, it may be defined that if the edge vector is going upwards, a counter is decreased, and if the edge vector is going downwards, the counter is increased. Typically this is defined in the standard but it can be also chosen depending on the current need. The value of the counter is stored in a buffer for each pixel on the screen. However, the pixels may be further divided into a grid of subpixels, wherein the counter values must be stored for each sample point in the pixel. Typically there is one sample point for each sub-pixel line in the grid of sub-pixels. However, there is no limitation to one sample per line. For example, 8*8 grid of sub-pixels may have 1-64 sample points.

When filling objects on the screen a coverage value for each pixel is computed as the objects on the screen might cover only a portion of a pixel. This is arranged by dividing pixels into a grid of sub-pixels. The number of the sub-pixels in the grid may be chosen depending on the application, for example a single pixel may be divided into a 16*16 grid of sub-pixels. The coverage value is computed based on samples. Samples are chosen from the sub-pixels and these samples are combined in a manner in which the selected sub-pixels are representative of all parts of the pixel. In a typical case for 16*16 grid of sub-pixels 16 samples are chosen so that the samples are not in the same horizontal, vertical or diagonal line with each other. Samples can be chosen based on predetermined sample patterns or randomly generated patterns. Based on the coverage values the fill values for each pixel can be computed for each object to be rendered. Finally the actual filling is performed based on the counter values and the chosen fill rule in accordance with standards.

The functionality mentioned above is traditionally implemented in a form of software. The software comprises typically an end-user application that calls programming interface with certain parameters. These parameters include the information needed for producing the graphics. The information may be, for example, a text message that the end-user application is going to display in a certain location with a certain font. One of these parameters is the fill mode mentioned above. Passing the fill mode parameter to the programming interface causes the corresponding functionality to fill the currently processed object according to the fill mode. These fill modes typically perform the actual filling according to the fill rules that are determined in standards, such as the OpenGL or the OpenVG mentioned above. However, a person ordinary skill in the art knows how to form new fill modes if needed.

The combination of the end-user application, programming interfaces and drivers produce the graphics that are shown to the end-user by means of computing device and display device. Typically this is done by rasterizing the screen to be displayed into a frame buffer. The end result in the frame buffer is then shown on the display.

The drawback with the technology mentioned above is that producing the end result to the frame buffer is computationally difficult task that requires a lot of computing resources. Thus, there is a need for enhanced solutions that are capable of producing the same end result with reduced requirement for computing resources.

### SUMMARY OF THE DISCLOSURE

The invention discloses an efficient method for improving use of different fill modes and a system filling using the method. The method according to the invention is implemented in graphics hardware. In an embodiment according to the present invention a filling procedure using graphics hardware that is capable of producing objects to be filled is described. Before filling, the edges of the objects are computed. The edges are typically computed so that the coverage value of each pixel is computed. The coverage value computation according to an embodiment of the present invention computes the number of samples inside the object. The number of the samples may be chosen for each application depending on the need of the image quality and computation power requirements.

In an embodiment according to present invention the location of the edges are stored into an edge buffer. The buffer may be a separate buffer or a pointer to a memory. The edge buffer comprises only the edges of the object to be rendered. When the object is actually is rendered, the present embodiment calls rendering function with at least one parameter. The possible parameters comprise, for example, the location of the objection in the edge buffer, the location of the object in the screen which is displayed to the user of a device and a fill mode. The fill mode parameter defines which fill rule is used for filling the object. For example, if the application comprises two different fill rules, such as odd-even and non-zero, the fill mode may be defined in a single bit. If the application comprises four different fill rules, two bits are required for defining fill mode, and so on.

In an embodiment of the invention the objects are rendered sequentially so that if the same object has to be drawn more than once the object is rendered only once. An offset value between the first instance of the invention and the further

In an embodiment of the invention the parameters are passed in a single register with the instruction call. If the parameter is a fill mode there are two different fill mode possibilities in the exemplary embodiment and, as such, the fill mode parameter can be represented by only one bit.

In a further embodiment objects with pre-determined or pre-computed edges are stored into the edge buffer.

A benefit of the present invention is that the filling of an object can be caused by executing the required instructions in the graphics hardware without performing further computations in the programming interfaces or libraries. The present invention also reduces the use of resources in the host device as the processor of the host device does not need to make the computations for producing the edges and filling the object. Furthermore, memory bandwidth is also saved when it is not necessary to transfer as much data to the graphics hardware as in the conventional solutions.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates an example of the edge computation according to the present invention,

FIG. 2 is a flow chart of an example embodiment of the present invention,

FIG. 3 is a block diagram of an example implementation of the present invention.

### DETAILED DESCRIPTION OF THE INVENTION

Reference will now be made in detail to the embodiments of the present invention, examples of which are illustrated in the accompanying drawings.

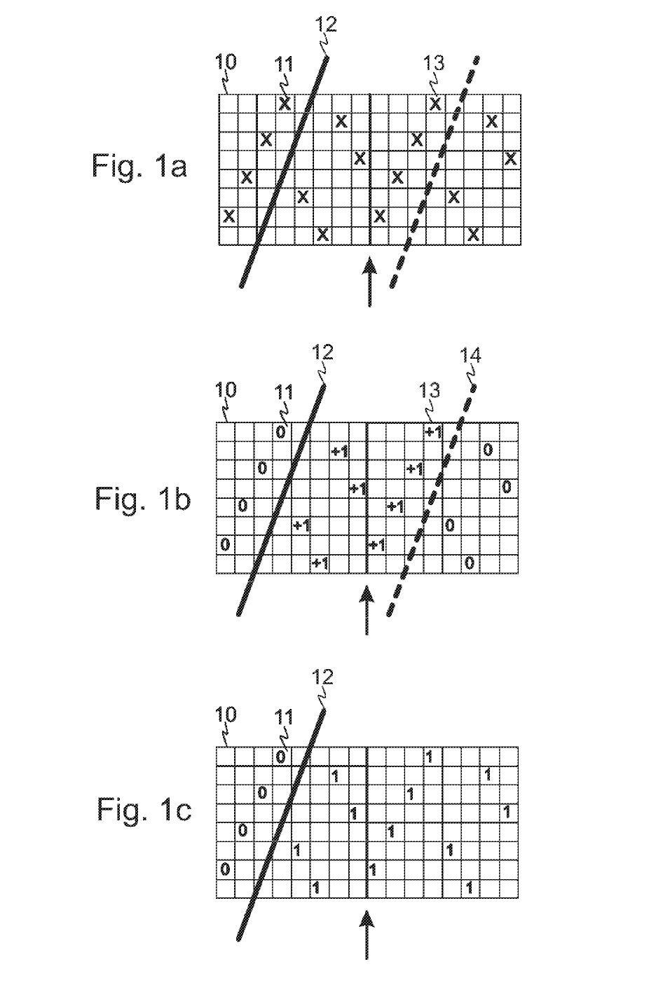

In FIG. 1 an example of the edge computation according to the present invention is disclosed. In FIG. 1a the sample construction is explained. In the example pixels are divided into an 8*8 grid of sub-pixels. Thus, eight samples per pixel are selected. Both of the pixels 10 and 15 thus have eight samples. Examples of the samples are referred with signs 11 and 13. In FIG. 1a an edge 12 hits pixel 10. Line 14 is for illustration purposes only for demonstrating the corresponding line position in relation to samples of the pixel 15.

In FIG. 1b counters are associated with the samples that are used. In the example the samples in lines 2, 4, 6 and 8 are within the object to be rendered and thus cause a change to the counters in the first pixel 10. As counters for the lines 1, 3, 5 and 7 are not altered in the first pixel, they must be altered in the second pixel 15. Line 14 is only for illustration purpose. With the help of the line 14 it is easy to see which counters have not been altered in the previous pixel as they are on the left side. The counters in the lines 2, 4, 6 and 8 are not altered again in the second pixel 15.

In FIG. 1c the result of the function is illustrated. As the pixel 15 is inside the object, it must be completely filled. In this example there are no further edges. Thus, the pixel is meant to be filled with the same color and all counters have the same value in the counters. The counters are modified according to the present standards and the change in the counter value may be +1 or −1 depending on the edge direction. Assuming that in the example of FIG. 1 we have the leftmost edge of the object, there may be a further edge in the right limiting the object. The limiting edge decreases/increases the values of the counters correspondingly.

According to the present invention the edges are then stored into the edge buffer. It is not necessary to compute the edges according to the method described above but any suitable edge computation method is accepted. The edge buffer according to the present invention is an allocated portion of memory that may be allocated depending on the need. Typically the memory is on the graphics device but also the central memory of the host device may be used if necessary.

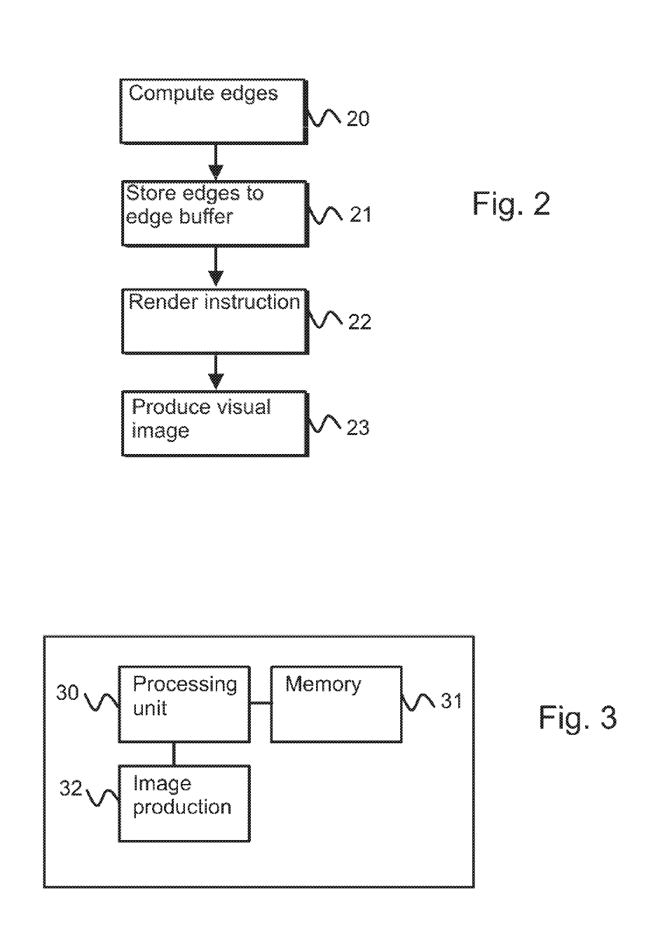

FIG. 2 discloses a method according to an example embodiment of the invention. In the method first the edges are computed, step 20. The edges may be computed, for example, as described above. The edges may be computed in dedicated graphics hardware or they can be computed in advance and. However, in both cases computing principles which are similar to described above apply. Then, the computed edges are stored to the edge buffer, step 21. In an alternative embodiment, wherein edges are computed in advance, the edges are transferred to the edge buffer from other storage location. The edge buffer may a separate buffer or a portion of memory that is referred with a pointer to the edge buffer. Typically to edge buffer is a portion of the memory as it is easier to change the dimensions of the buffer depending on the application needs.

When an object is rendered from the edge buffer, a render instruction or a set of instructions for causing the rendering is issued, step 22. The render instruction may comprise a plurality of parameters, such as a pointer to the edge buffer, target coordinates and further rendering options, such as the fill mode or mapping. If there are only two different fill modes available, such as non-zero and odd-even fill modes, only one bit is required. It may be desirable for all the parameters to fit into one register or as few registers as possible in order to improve the efficiency. The execution of the render instruction or the corresponding set instructs the graphics hardware to fill the currently processed object to a buffer or a portion of memory. The fill mode parameter is extracted from the set of parameters and the object is filled according to the fill rules corresponding to the given fill mode parameter.

The render instruction may be issued to the same object more than once. This arrangement enables the option of rendering the same object to multiple locations with different fill modes supported by the used hardware by using the same edge data. As the edges are not computed again, the resources (e.g., memory, packaging and/or die size, power consumption, computational efficiency, etc.) of the device are saved. Finally the object is actually rendered, step 23.

FIG. 3 discloses an example embodiment of a system according to the present invention. The system is typically a graphics block that is configured to do also other graphics related tasks that are not related to the present invention. The system comprises a processor 30, a memory 31 and image production means 32. The processor 30 is configured to execute graphics related instructions received from a host device. The processor 30 is coupled to, or in communication with, the memory 31 for storing rendering related data, such as an edge buffer and a buffer for the rendered image. The memory may be internal and/or external, however, in most cases the internal memory is preferred. The processor is also coupled to, or in communication with, image production means 32 that may comprise, for example, a connector to which a display device is connected to.

In an embodiment of the invention the system disclosed in the example of FIG. 3 is included in a mobile device, personal computer or other computing device having graphical user interface. In the embodiment the system is configured to execute the method disclosed in the example of FIG. 2.

It is obvious to a person skilled in the art that with the advancement of technology, the basic idea of the invention may be implemented in various ways. The invention and its embodiments are thus not limited to the examples described above; instead they may vary within the scope of the claims.

1. A method for rendering vector graphics objects in a graphics device, which method comprises:
computing edges of an object to be rendered;
rendering said object upon an execution of a rendering instruction, wherein
parameters of said instruction comprise the source coordinates of the object in a memory, destination coordinates of the object in a memory and a fill mode.

2. The method according to claim 1, wherein the parameters of said instruction are passed within at least one register.

3. The method according to claim 1, wherein rendering said object more than once based on said edges using different fill modes.

4. The method according to the claim 1, wherein the edges have been pre-computed.

5. A graphics processing block comprising:
a processor;
a memory in communication with said processor; and
wherein a processor is configured to:
compute edges of an object to be rendered;
render said object upon an execution of a rendering instruction, wherein parameters of said instruction comprise the source coordinates of the object in said memory, destination coordinates of the object in said memory and a fill mode.

6. The graphics block according to claim 5, wherein the parameters of said instruction are passed to said processor within at least one register of said processor.

7. The graphics block according to claim 5, wherein the processor is configured to render said object more than once based on said edges using different fill modes.

8. The graphics block according to claim 5, wherein the processor is configured to use pre-computed edges.

9. A system for rendering vector graphics objects, which system comprises:
means for computing edges of the object to be rendered; and
means for rendering said object upon an execution of a rendering instruction, wherein parameters of said instruction comprise the source coordinates of the object a memory, destination coordinates of the object in a memory and a fill mode.

10. The system according to claim 9, wherein the parameters of said instruction are passed to means for rendering within at least one register of said means for rendering.

11. The system according to claim 9, wherein means for rendering are configured to render said object more than once based on said edges using different fill modes.

12. The system according to claim 9, wherein the system is configured to use pre-computed edges.
